(19) United States
(12) Patent Application Publication
(10) Pub. No.: US 2021/0256473 A1
(43) Pub. Date: Aug. 19, 2021

(54) METHOD FOR LICENSING PROPRIETARY RIGHTS USING A BLOCKCHAIN

(71) Applicant: OPEREM INC., Toronto (CA)

(72) Inventors: Timothy M. Londergan, Seattle, WA (US); Nicholas Gibson, Tokyo (JP); Nobuhito Koya, Tokyo (JP); Christopher A. Wiklof, Everett, WA (US)

(21) Appl. No.: 17/188,924

(22) Filed: Mar. 1, 2021

Related U.S. Application Data
(63) Continuation-in-part of application No. PCT/US2019/048421, filed on Aug. 27, 2019.
(60) Provisional application No. 62/723,613, filed on Aug. 28, 2018.

(51) Int. Cl. G06Q 10/10; G06F 3/0484; H04L 9/06; H04L 9/32

(52) U.S. Cl. CPC G06Q 10/101; G06Q 10/103; H04L 2209/38; H04L 9/0643; H04L 9/3247; G06F 3/04842

(57) ABSTRACT

A computer method for licensing proprietary rights using a blockchain includes displaying a graphical user interface (GUI) to a first user representing a first enterprise. The GUI includes a selection object for selecting one item from one or more standard proprietary rights agreements. The computer method receives, into a server computer from the first user via the GUI, a selection of one of the one or more standard proprietary rights agreements for making a proprietary rights agreement with a second enterprise, and provides, via the GUI, an executable electronic document corresponding to the selected proprietary rights agreement to a user having signature authority representing the first enterprise and to a user having signature authority representing the second enterprise. The computer method further receives, into the server computer, data corresponding to execution of the electronic document from the first enterprise and the second enterprise, and records the execution of the selected proprietary rights agreement between the first and second enterprises on a blockchain.

### SUMMARY

According to an embodiment, a computer method for licensing proprietary rights using a blockchain includes displaying a graphical user interface (GUI) to a first user representing a first enterprise. The GUI includes a selection object for selecting one item from one or more standard proprietary rights agreements. The computer method receives, into a server computer from the first user via the GUI, a selection of one of the one or more standard proprietary rights agreements for making a proprietary rights agreement with a second enterprise, and provides, via the GUI, an executable electronic document corresponding to the selected proprietary rights agreement to a user having signature authority representing the first enterprise and to a user having signature authority representing the second enterprise. The computer method further receives, into the server computer, data corresponding to execution of the electronic document from the first enterprise and the second enterprise, and records the execution of the selected proprietary rights agreement between the first and second enterprises on a blockchain.

### BRIEF DESCRIPTION OF THE DRAWINGS

FIG. 1 is a flowchart showing a computer method for establishing enterprise collaboration including a license to a proprietary right recorded on a blockchain, according to an embodiment.

FIG. 2 is a diagram showing a graphical user interface (GUI) for selecting one of a plurality of proprietary rights agreements, according to an embodiment.

FIG. 3 is a flowchart showing a computer method for establishing collaboration between enterprises, according to an embodiment.

FIG. 4 is a diagram illustrating contractual relationships between enterprises, according to various embodiments.

FIG. 5 is a block diagram of a computer system showing principal components for supporting licensing of proprietary rights between enterprises, according to an embodiment.

FIG. 6 is a state diagram indicating an approach to modularizing a computer method for promulgating matches between complementary enterprises, according to an embodiment.

FIG. 7 is a diagram showing relationships between data entities used to make matches between enterprises, according to an embodiment.

FIG. 8 is a flowchart for matching first and second enterprises, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

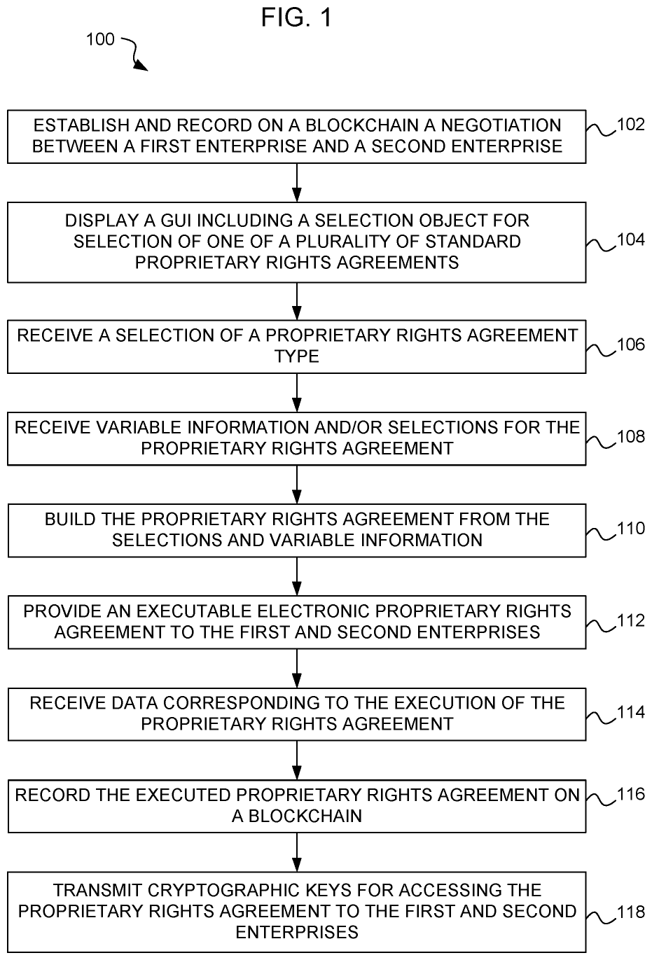

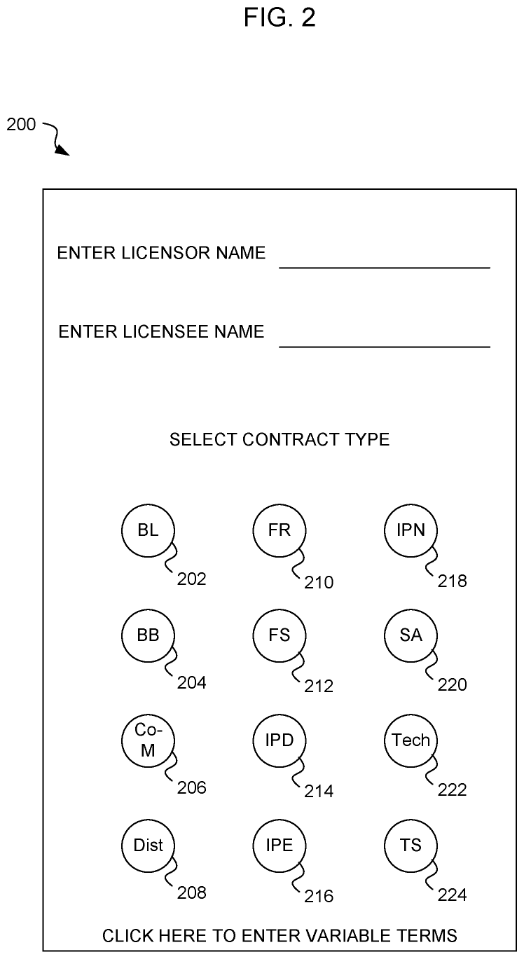

FIG. 1 is a flowchart showing a computer method 100 for establishing enterprise collaboration including a license to a proprietary right recorded on a blockchain, according to an embodiment. FIG. 2 is a diagram showing a graphical user interface (GUI) 200 for selecting one of a plurality of proprietary rights agreements, according to an embodiment. Referring to FIGS. 1 and 2, according to an embodiment, a computer method 100 for licensing proprietary rights using a blockchain includes, in step 104, displaying a graphical user interface (GUI) to a first user representing a first enterprise. In an embodiment, the GUI includes one or more selection objects (e.g., 202 to 224) for selecting one from a respective one or more standard proprietary rights agreements. Step 106 includes receiving, into a server computer from the first user via the GUI, a selection of one of the one or more standard proprietary rights agreements for making a proprietary rights agreement with a second enterprise. Step 112 includes providing, via the GUI, an executable electronic document corresponding to the selected proprietary rights agreement to a user having signature authority and representing the first enterprise and to a user having signature authority and representing the second enterprise. Step 114 includes receiving, into the server computer, data corresponding to execution of the electronic document from the first enterprise and the second enterprise. Step 116 includes recording the execution of the selected proprietary rights agreement between the first and second enterprises on a blockchain.

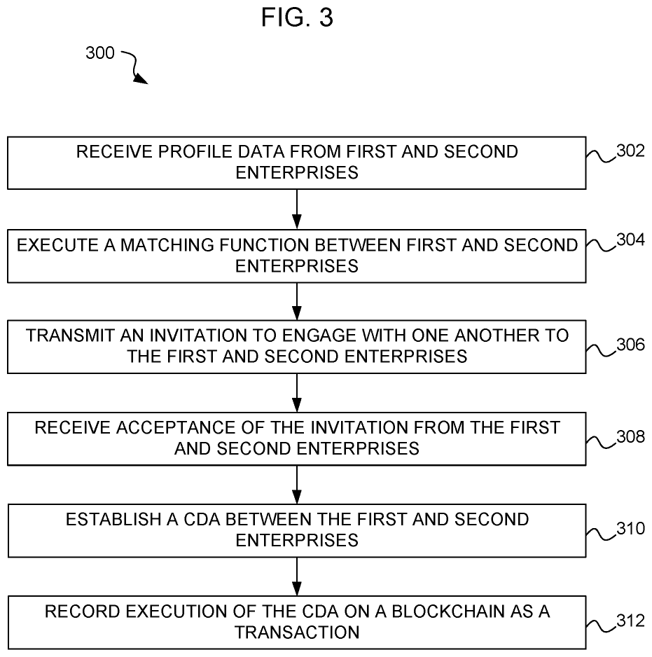

FIG. 3 is a flowchart showing a computer method 300 for establishing collaboration between enterprises, according to an embodiment.

According to an embodiment, referring to FIGS. 1 and 3, the computer method 100 further includes, in step 102, establishing, and recording as a transaction on the blockchain, a negotiation between the first and second enterprises. In an embodiment, establishing a negotiation between the first and second enterprises, in step 102, may include one or more of the operations of the computer method 300. Specifically, the establishing of the negotiation between the first and second enterprises of step 102 may include, in step 302, receiving, into the server computer, profile data from the first and second enterprises. In an embodiment, establishing the negotiation between the first and second enterprises, in step 102, may further include, in step 306, transmitting, to the first and/or second enterprises, an invitation to engage. In an embodiment, establishing the negotiation between the first and second enterprises, in step 102, includes, in step 308, receiving acceptance of the invitation from the first and second enterprises, and may further include, in step 310, establishing a confidential disclosure agreement (CDA) (also referred to as a non-disclosure agreement, NDA) between the first and second enterprises. In an embodiment, recording the negotiation between the first and second enterprises, in step 102, may include, in step 312, recording execution of the CDA on the blockchain as a transaction. In an embodiment, establishing a negotiation between the first and second enterprises, in step 102, may include, in step 304, executing, with the server computer, a matching function between the first and second enterprises. In an embodiment, the matching function, in step 304, may include matching complementary characteristics of the first and second enterprises. Here, the term “matching” does not necessarily require identity or 100% compatibility of the characteristics, instead meaning that complementary characteristics may be considered matched if they are within a predetermined threshold difference or correspond to one or more of a predetermined set of reference characteristics. In an embodiment, the matching function, in step 304, may include differing or matching metadata about the first and second enterprises, with no analysis per se being performed.

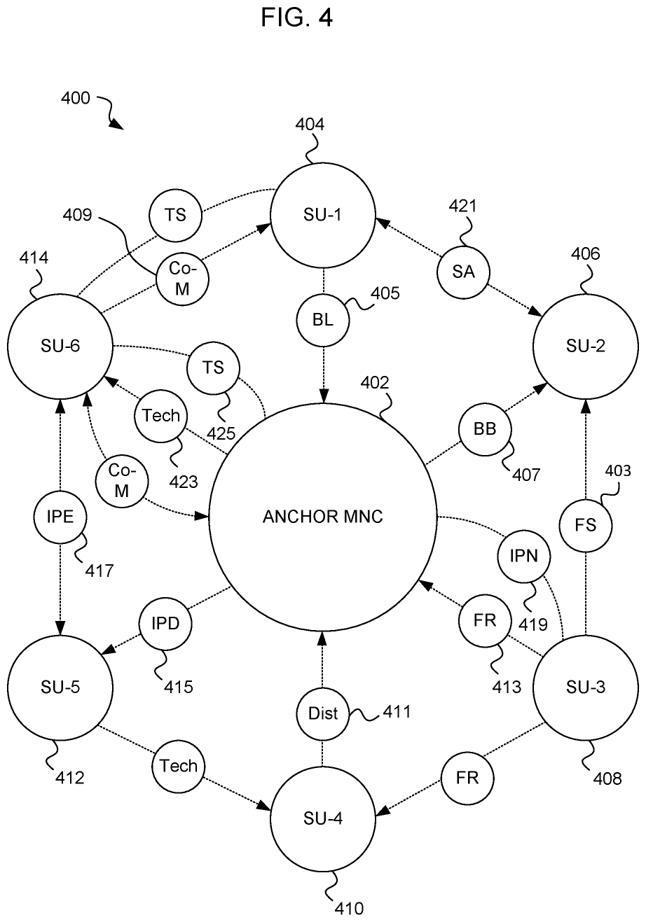

FIG. 4 is a diagram illustrating contractual relationships 400 between enterprises, according to various embodiments.

According to an embodiment, referring to FIGS. 3 and 4, the matching function, in step 304, may include matching a multinational corporation (MNC) 402 with a start-up company 404, 406, 408, 410, 412, 414. In an embodiment, this may include identifying a start-up company having characteristics (e.g., technical depth, financial backing, a desired individual, sales channels, and/or a location) desired by the multinational corporation 402. Additionally or alternatively, the matching function may include matching other types of organizations such as universities, start-up companies, small, medium, or large established companies, consultants, law firms, technology companies, capital sources such as investment banks, and/or MNCs having complementary capabilities. In an embodiment, the matching function, in step 304, may include consideration, comparison or evaluation of differing proprietary rights held by the first and second enterprises. In an embodiment, the matching function used in step 304 may include consideration, comparison or evaluation of differing technical capabilities of the first and the second enterprises. In an embodiment, the matching function, in step 304, may include consideration, comparison or evaluation of non-matching production capabilities of the first and second enterprises. In an embodiment, the matching function, in step 304, may include consideration, comparison or evaluation of differing territories addressed by the first and second enterprises. In an embodiment, the matching function, in step 304, may include consideration, comparison or evaluation of differing sales channels used by the first and second enterprises. In an embodiment, the matching function, in step 304, may include consideration, comparison or evaluation of differing sizes of the first and second enterprises. In an embodiment, the matching function, in step 304, may include consideration, comparison or evaluation of differing financial resources of the first and second enterprises.

According to an embodiment, referring to FIGS. 1, 2 and 4, displaying the GUI to the first user, in step 104, may include displaying a selection object 202 for selecting a brand license 405. In an embodiment, a start-up company 404 may want to leverage and/or use a multinational corporation 402 brand in conjunction with its products and/or services. In an embodiment, the first user, in step 104, may represent a start-up company 404 and the second enterprise may be a multinational corporation 402. In an embodiment, the first user, in step 104, may represent a multinational corporation 402 and the second enterprise may be a start-up company 404. In an embodiment, receiving the selection of one of the one or more standard proprietary rights agreements, in step 106, may include receiving the selection of the brand license 405. In an embodiment, providing the executable electronic document, in step 112, may include providing an executable electronic brand license 405. In an embodiment, recording the execution of the proprietary rights agreement, in step 116, may include recording the execution of the brand license 405.

In an embodiment, displaying the GUI to the first user, in step 104, may include displaying a selection object 204 for selecting a build-to-buy agreement 407 (build-to-buy refers to a license to technology with a future option, by the licensor to buy the licensee or assets thereof). In an embodiment, a multinational corporation 402 may license an intellectual property (IP) asset to a start-up company 406, alternatively with an option to buy back a business. The multinational corporation 402 may want an ongoing relationship with the start-up company 406. In an embodiment, receiving the selection of one of the one or more standard proprietary rights agreements, in step 106, may include receiving the selection of the build-to-buy agreement 407. In an embodiment, providing the executable electronic document, in step 112, may include providing an executable build-to-buy agreement 407. In an embodiment, recording the execution of the proprietary rights agreement, in step 116, may include recording the execution of the build-to-buy agreement 407.

In an embodiment, displaying the GUI to the first user, in step 104, may include displaying a selection object 206 for selecting a co-marketing agreement 409. In an embodiment, marketing activity may be leveraged by a start-up company 414 to a multinational corporation 402. The co-marketing agreement 409 may tie with a brand license 405. In an embodiment, receiving the selection of one of the one or more standard proprietary rights agreements, in step 106, may include receiving the selection of the co-marketing agreement 409. In an embodiment, providing the executable electronic document, in step 112, may include providing an executable electronic co-marketing agreement 409. In an embodiment, recording the execution of the proprietary rights agreement, in step 116, may include recording the execution of the co-marketing agreement 409.

In an embodiment, displaying the GUI to the first user, in step 104, may include displaying a selection object 208 for selecting a distribution agreement 411. In an embodiment, distribution channels may be leveraged from a multinational corporation 402 by a start-up company 410. In an embodiment, receiving the selection of one of the one or more standard proprietary rights agreements, in step 106, may include receiving the selection of the distribution agreement 411. In an embodiment, providing the executable electronic document, in step 112, may include providing an executable electronic distribution agreement 411. In an embodiment, recording the execution of the proprietary rights agreement, in step 116, may include recording the execution of the distribution agreement 411.

In an embodiment, displaying the GUI to the first user, in step 104, may include displaying a selection object 210 for selecting a foreign rights agreement 413. In an embodiment, a start-up company 408 may license an IP asset to a multinational corporation 402 and/or a second start-up company 410 in a specific geography in which the second start-up company is not operating. In an embodiment, receiving the selection of one of the one or more standard proprietary rights agreements, in step 106, may include receiving the selection of the foreign rights agreement 413. In an embodiment, providing the executable electronic document, in step 112, may include providing an executable electronic foreign rights agreement 413. In an embodiment, recording the execution of the proprietary rights agreement, in step 116, may include recording the execution of the foreign rights agreement 413.

In an embodiment, displaying the GUI to the first user, in step 104, may include displaying a selection object 212 for selecting a foreign rights sublicense agreement 403. In an embodiment, a start-up company 408 sublicense an IP asset to another startup company 406. In an embodiment, receiving the selection of one of the one or more standard proprietary rights agreements, in step 106, may include receiving the selection of the foreign rights sublicense agreement 403. In an embodiment, providing the executable electronic document, in step 112, may include providing an executable electronic foreign rights sublicense agreement 403. In an embodiment, recording the execution of the proprietary rights agreement, in step 116, may include recording the execution of the foreign rights sublicense agreement 403.

In an embodiment, displaying the GUI to the first user, in step 104, may include displaying a selection object 214 for selecting an IP sales agreement 415. In an embodiment, a multinational corporation 402 may sell and/or buy IP assets from a start-up company 412. In an embodiment, receiving the selection of one of the one or more standard proprietary rights agreements, in step 106, may include receiving the selection of the IP sales agreement 415. In an embodiment, providing the executable electronic document, in step 112, may include providing an executable electronic IP sales agreement 415. In an embodiment, recording the execution of the proprietary rights agreement, in step 116, may include recording the execution of the IP sales agreement 415.

In an embodiment, displaying the GUI to the first user, in step 104, may include displaying a selection object 216 for selecting an exclusive IP licensing agreement 417. In an embodiment, exclusive IP rights may be licensed in a specific region and/or a specific field of use. In an embodiment, receiving the selection of one of the one or more standard proprietary rights agreements, in step 106, may include receiving the selection of the exclusive IP licensing agreement 417. In an embodiment, providing the executable electronic document, in step 112, may include providing an executable electronic exclusive IP licensing agreement 417. In an embodiment, recording the execution of the proprietary rights agreement, in step 116, may include recording the execution of the exclusive IP licensing agreement 417.

In an embodiment, displaying the GUI to the first user, in step 104, may include displaying a selection object 218 for selecting a non-exclusive IP licensing agreement 419. In an embodiment, open non-exclusive IP rights may be licensed by a start-up company 408 and/or a multinational corporation 402. In an embodiment, receiving the selection of one of the one or more standard proprietary rights agreements, in step 106, may include receiving the selection of the non-exclusive IP licensing agreement 419. In an embodiment, providing the executable electronic document, in step 112, may include providing an executable electronic non-exclusive IP licensing agreement 419. In an embodiment, recording the execution of the proprietary rights agreement, in step 116, may include recording the execution of the non-exclusive IP licensing agreement 419.

In an embodiment, displaying the GUI to the first user, in step 104, may include displaying a selection object 220 for selecting a supply agreement 421. In an embodiment, a start-up company 404 distributes an ongoing supply of finished goods and/or materials based on an IP asset to a multinational corporation 402 and/or a second start-up company. In an embodiment, receiving the selection of one of the one or more standard proprietary rights agreements, in step 106, may include receiving the selection of the supply agreement 421. In an embodiment, providing the executable electronic document, in step 112, may include providing an executable electronic supply agreement 421. In an embodiment, recording the execution of the proprietary rights agreement, in step 116, may include recording the execution of the supply agreement 421.

In an embodiment, displaying the GUI to the first user, in step 104, may include displaying a selection object 222 for selecting a technology co-development agreement 423. In an embodiment, platforms and/or products of a multinational corporation 402 may be integrated with joint product development of modules, plug-ins or extensions of a start-up company 414. In an embodiment, platforms and/or products of a startup, university, small business, or the like 412 may be integrated with joint product development of modules, plugins or extensions of another start-up company, university, small business or the like 410. In an embodiment, receiving the selection of one of the one or more standard proprietary rights agreements, in step 106, may include receiving the selection of the technology co-development agreement 423. In an embodiment, providing the executable electronic document, in step 112, may include providing an executable electronic technology co-development agreement 423. In an embodiment, recording the execution of the proprietary rights agreement, in step 116, may include recording the execution of the technology co-development agreement 423.

In an embodiment, displaying the GUI to the first user, in step 104, may include displaying a selection object 224 for selecting a trade secrets and/or know-how transfer agreement 425. In an embodiment, a multinational corporation 402 and/or a start-up company 414 may want to share trade secrets, training, lab access, etc., with a second start-up company. In an embodiment, receiving the selection of one of the one or more standard proprietary rights agreements, in step 106, may include receiving the selection of the trade secrets and/or know-how transfer agreement 425. In an embodiment, providing the executable electronic document, in step 112, may include providing an executable electronic trade secrets and/or know-how transfer agreement 425. In an embodiment, recording the execution of the proprietary rights agreement, in step 116, may include recording the execution of the trade secrets and/or know-how transfer agreement 425.

In an embodiment, the first enterprise may be a multinational corporation and/or a large entity having over 400 employees, and the second enterprise may be a start-up enterprise and/or a small entity having under 400 employees. In an embodiment, the first enterprise may be a start-up enterprise and/or a small entity having under 400 employees, and the second enterprise may be a multinational corporation and/or a large entity having over 400 employees. In an embodiment, at least one of the first enterprise and the second enterprise may be a university and/or research organization. In an embodiment, at least one of the first enterprise and the second enterprise may be a start-up enterprise and/or a small entity having under 400 employees. In an embodiment, at least one of the first enterprise and the second enterprise may be a multinational corporation and/or a large entity having over 400 employees.

In an embodiment, recording the execution of the selected proprietary rights agreement, in step 116, may include hashing the executed agreement. In an embodiment, recording the execution of the selected proprietary rights agreement, in step 116, may include encrypting data corresponding to the executed agreement. In an embodiment, recording the execution of the selected proprietary rights agreement, in step 116, may include recording data corresponding to the executed agreement as a transaction on the blockchain. In an embodiment, recording the execution of the selected proprietary rights agreement, in step 116, may include recording data corresponding to the executed agreement as metadata on the blockchain.

In an embodiment, the blockchain may include a distributed ledger. In an embodiment, the blockchain may include a permissioned blockchain. In an embodiment, the blockchain may include a private blockchain. In an embodiment, the blockchain may include a public blockchain.

In an embodiment, the selected proprietary rights agreement may include a non-disclosure agreement (NDA) and/or a confidential disclosure agreement (CDA) that may be one-way (unilateral), two-way (bilateral), or may involve cross-agreements between more than two parties (multilateral).

According to an embodiment, referring to FIG. 1, the computer method 100 further includes, in step 108, receiving variable information pertaining to the proprietary rights agreement via the GUI. In an embodiment, receiving the variable information, in step 108, may include receiving radio button selections (e.g., made by the first user) in the GUI. In an embodiment, receiving the variable information, in step 108, may include receiving entries in fields in the GUI. In an embodiment, receiving the variable information, in step 108, may include receiving an uploaded term sheet. In an embodiment, receiving the variable information, in step 108, may include receiving at least one negotiated item. In an embodiment, receiving the variable information, in step 108, may include receiving at least one selected from the group consisting of a price, a duration, a territory, a payment frequency, a payment schedule, a patent number, a trademark, an application serial number, a publication number, and an exclusion.

According to an embodiment, referring to FIG. 1, the computer method 100 further includes, in step 110, building the proprietary rights agreement by combining standard language with the received variable information. In an embodiment, recording the executed proprietary rights agreement, in step 116, may include hashing the executed proprietary rights agreement. In an embodiment, recording the executed proprietary rights agreement, in step 116, may include hashing the executed proprietary rights agreement via a hash tree, e.g., a Merkle tree. In an embodiment, recording the executed proprietary rights agreement, in step 116, may include encrypting the executed proprietary rights agreement. In an embodiment, recording the executed proprietary rights agreement, in step 116, may include recording on at least one selected from the group consisting of a public blockchain, an etherium ERC-20 blockchain, a permissioned blockchain, a private blockchain, and a distributed ledger.

According to an embodiment, referring to FIG. 1, the computer method 100, in step 118, includes transmitting cryptographic keys to the first and the second enterprises.

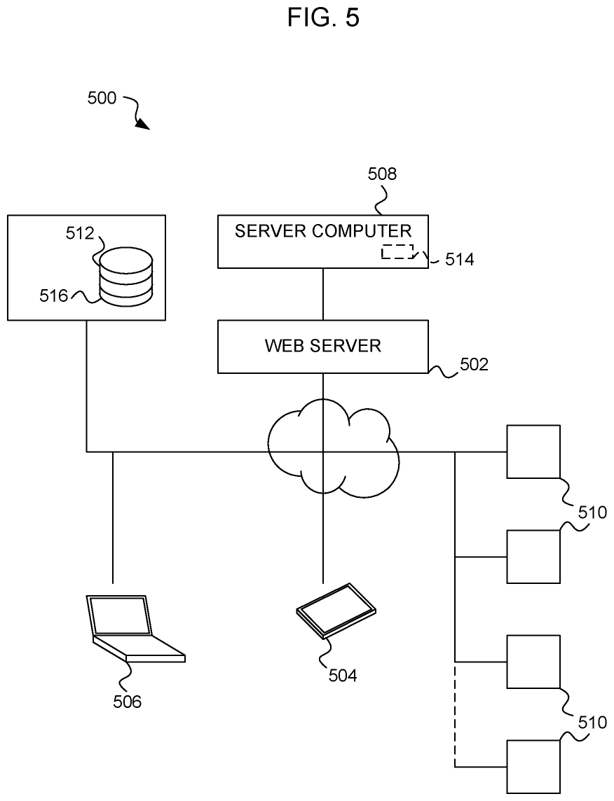

FIG. 5 is a block diagram of a computer system 500 showing principal components in a computer system for supporting licensing of proprietary rights between enterprises, according to an embodiment. The computer system 500 may include a webserver 502 configured to output a first graphical user interface (GUI) to a first device 504 corresponding to and/or operated by a first enterprise. The webserver 502 may be further configured to output a second GUI to a second device 506 corresponding to and/or operated by a second enterprise, according to an embodiment. The computer system 500 may include a server computer 508, operatively coupled to the webserver 502, and configured to perform processing described herein, and transmit communications intended to the respective first enterprise electronic device 504, second enterprise electronic device 506, as well as distributed storage and blockchain nodes 510 to the webserver 502. Optionally, the server computer 508 may include a distributed memory node and/or one or more blockchain full nodes, in which case communications to and from distributed storage and blockchain may occur within the block 508 indicated “server computer”.

According to an embodiment, the computer system 500 may include a plurality of devices 510 operatively coupled (e.g., via Internet or other computer network) to the webserver 502 and carrying the blockchain and/or distributed memory. The webserver 502 may be configured to transmit data and transactions to the plurality of devices 510, according to an embodiment. The plurality of devices 510 may be configured to collectively carry transactions between the first and second enterprise and data associated therewith, according to an embodiment. The webserver 502 may be configured to receive and forward transactions and data to the server computer 508, according to an embodiment.

According to an embodiment, the server computer 508 may be further configured to receive data, described herein, mediated by a first enterprise electronic wallet 512 and a second enterprise electronic wallet 514 via the webserver 502. The server computer 508 may cause transmission data to distributed memory mediated by the first enterprise electronic wallet 514 and the second enterprise electronic wallet 516 via the webserver 502, according to an embodiment.

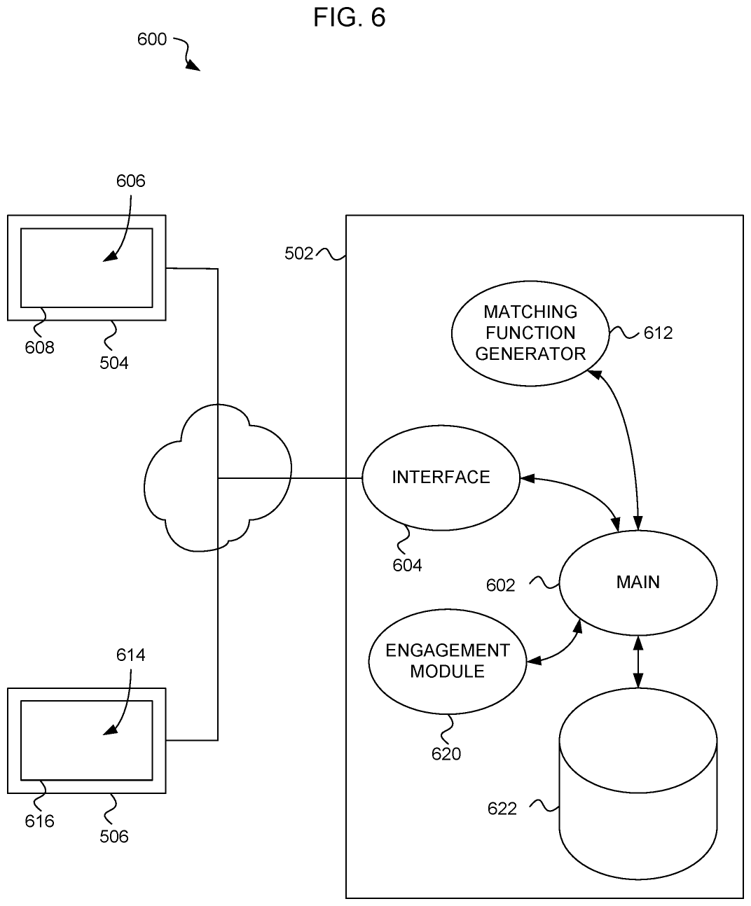

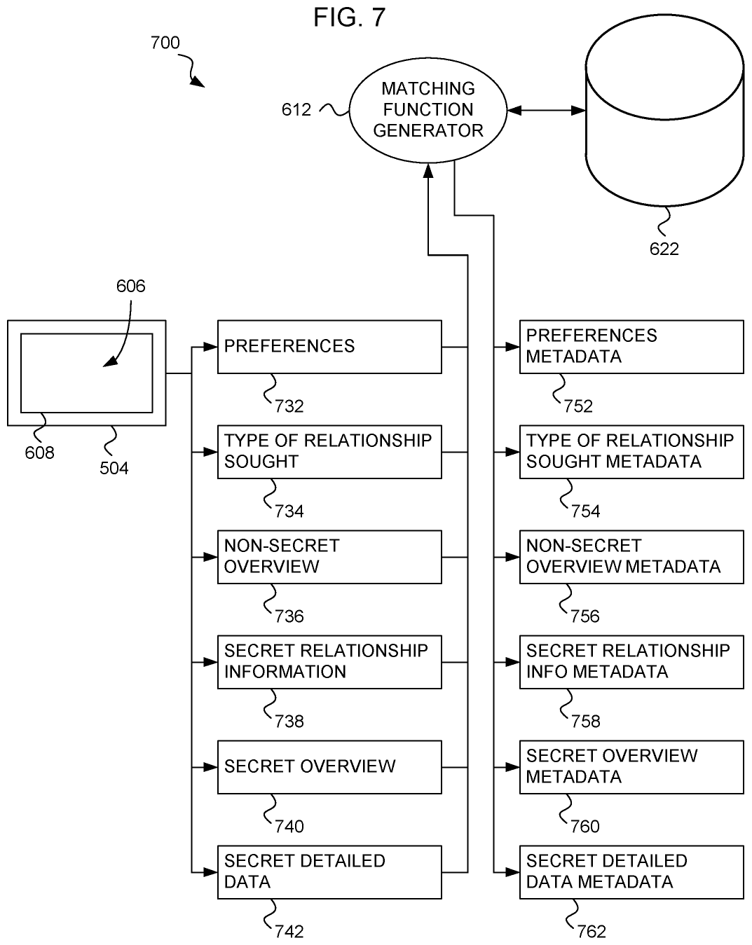

FIG. 6 is a state diagram 600 indicating an approach to modularizing a computer method for promulgating matches between complementary enterprises, according to an embodiment. A main program 602 may operate according to an interrupt or multiplexed architecture on a server computer 508. The main program 602 may call an interface module 604 configured to operatively couple states executed and supported by at least one server computer 508 to a first user interface (GUI) 606 displayed on an electronic display 608 of a first enterprise electronic device 504. The interface module 604 is configured to receive first enterprise information input, including information corresponding to data entities shown in FIG. 7. The interface module 604 cooperates with at least the main program 602 to store first user information as one or more data entities at a distributed memory (e.g., FileCoin or InterPlanetary File System (IPFS)) location (typically defined by a multihash of the respective data entity). In an embodiment, a multihash location is encrypted and recorded in a block chain transaction, which also provides time stamping and proof of existence. The block chain transaction may be inspected using a block explorer program, for example.

In an embodiment, the main program 602 calls a matching function generator 612. The matching function generator 612 may be enabled by the first enterprise by actuating an object in the first GUI 606 to cause generation of matches corresponding to the entered first enterprise information, wherein said matches include an identity of one or more second enterprises which provide second enterprise capabilities complementary to first enterprise capabilities, stated first enterprise type(s) of relationship(s) sought, and first enterprise preference(s). Moreover, said matches may include an identity of one or more second enterprises for which the first enterprise provides complementary first enterprise capabilities, second type(s) of relationship(s) sought, and second enterprise preference(s). See description corresponding to FIG. 7 for examples.

The matching function generator 612 may operate to abstract information provided by the first enterprise into metadata according to a library of metadata values and save the metadata in a database or as data saved and accessed according to the cooperation between distributed memory and block chain transaction tracking described above. Additionally or alternatively, information may be received from the first enterprise via the GUI 606 in a form directly usable as metadata fields, for example by selection of radio buttons, check boxes, and the like. Metadata corresponding to a transaction instance received from the first enterprise may be saved in an encrypted form. The matching function generator may cross-tabulate first enterprise metadata against metadata corresponding to second enterprise instances and optionally stack rank one or more second enterprises forming a best match to the first enterprise information.

In an embodiment, the main program 602 may facilitate an exchange of information between a first enterprise and a second enterprise via respective first enterprise and second enterprise GUIs 606, 614 displayed on electronic displays 608, 616 of first and second enterprise devices 504, 506. In an embodiment, the main program 602 actuates the interface module 604 to present first enterprise non-secret overview of goods and/or services to the second enterprise, and present second enterprise goods and/or services to the first enterprise. Examples of first and second enterprise goods and services are provided in conjunction with FIG. 4.

The presentation of non-secret overviews of goods and/or services to the respective first and second parties may include provision of an upvote object in the respective GUI's 606, 614. The main program 602 may receive respective upvotes via the interface module 604.

Upon receiving respective upvotes from the first and second enterprises, the main program 602, may call an engagement module 620. The engagement module provides secrecy agreements and optionally provides for negotiation of secrecy agreements to and between the first and second enterprises. Upon receiving execution of one or more accepted secrecy agreements, the engagement module 620 may notify the main program 602. The main program may call the interface module 604 to present secret information (e.g., see 738, 740, 742, FIG. 7) from the first enterprise to the second enterprise, and/or present secret information (e.g., see 738, 740, 742, FIG. 7) from the second enterprise to the first enterprise. The presentation of the secret information may be accompanied by a “proceed” object in the first and second GUIs 606, 614. Receipt of actuation of the “proceed” object from the first enterprise and the second enterprise may cause the engagement module 620 to proceed with stepwise presentation of additional agreement(s), additional information, and/or otherwise present information intended to move a relationship (e.g., see FIG. 4) forward. Types of additional agreement(s) are described in conjunction with FIG. 4.

FIG. 7 is a diagram 700 showing relationships between data entities used to make matches between enterprises, according to an embodiment.

Referring to FIG. 7, the inventors contemplate various computer operations, at least some of which may be termed artificial intelligence (AI) computer operations, used to obtain the matching function described elsewhere herein. For example, an agent or employee of the first enterprise may enter, via a graphical user interface 606 (GUI) of an electronic device 504 operatively coupled to a server computer 502, one or more user preferences 732, a type of relationship(s) sought 734, a non-secret overview of goods and/or services 736 which the first enterprise intends to find a partner enterprise, a secret overview of the specific goods and/or services 740, one or more secret details related to the type of relationship(s) sought 738, and secret detailed data related to the goods and/or services 742 for which the first enterprise desires a partner enterprise to capitalize, finance, design, implement, manufacture, and/or otherwise contribute to monetization and/or actualization.

A matching function generator process 612 executed by the server computer 502 reads the user entries 732, 734, 736, 738, 740, and 742, and generates respective metadata objects 752, 754, 756, 758, 760, and 762 corresponding to the user entries. The matching function generator process 612 may use natural language parsing, translation, Boolean, and/or Bayesian processes, and or reference to a look-up table (LUT) or library of metadata values to determine corresponding metadata objects 752, 754, 756, 758, 760, and 762. The metadata objects 752, 754, 756, 758, 760, and 762 may, for example, include strings, tables, and arrays as needed to capture unique aspects of the user entries 732, 734, 736, 738, 740, and 742.

Each data element 732, 734, 736, 738, 740, and 742 entered by the user (and each corresponding metadata element 752, 754, 756, 758, 760, 762) may be saved at a respective data storage location generated by a multi-hash of at least the data. Encrypted values corresponding to the multi-hashes may be written as carried data in a block chain transaction using one or more first enterprise-associated public key(s) and corresponding electronic wallet(s).

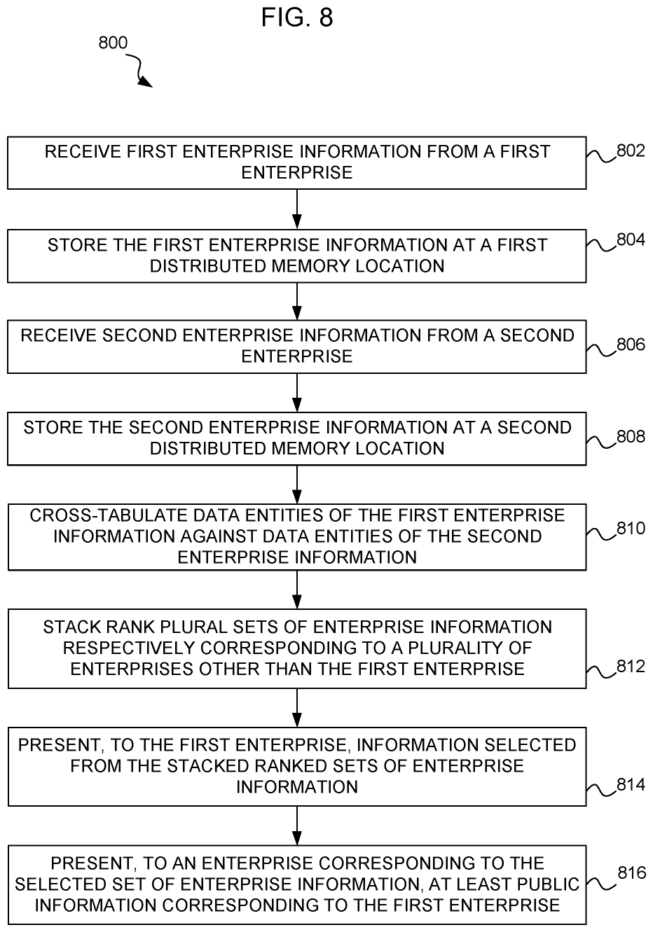

Turning to FIG. 8, according to an embodiment, executing a matching function between first and second enterprises in Step 304 of FIG. 3 may include, in step 802, receiving first enterprise information from the first enterprise, the first enterprise information including information corresponding to elements 732 to 742 of FIG. 7; i.e., one or more of preferences, type of relationship sought, non-secret overview information, secret relationship information, and secret detailed data. The method may further include, in step 804, storing the first enterprise information at a first distributed memory location. In step 806, the method may include receiving second enterprise information from the second enterprise, the second enterprise information including information corresponding to the one or more data entities. In step 808, the method may include storing the second enterprise information at a second distributed memory location. The method may further include, in step 810, cross-tabulating one or more of the data entities of the first enterprise information against corresponding data entities of the second enterprise information.

According to an embodiment, step 304 of executing a matching function between first and second enterprises may further include, at step 812, stack ranking plural sets of enterprise information corresponding respectively to a plurality of enterprises, other than the first enterprise, in order of best match of each respective set of enterprise information to the first enterprise information.

According to an embodiment, step 304 of executing a matching function between first and second enterprises may further include, at step 814, presenting, to the first enterprise, at least information from a selected set of enterprise information selected from the stack ranked sets of enterprise information. At step 816, the process may further include presenting, to an enterprise corresponding to the selected set of enterprise information, at least information corresponding to the first enterprise.

Additionally or alternatively, step 304 of executing a matching function between first and second enterprises may include abstracting the first enterprise information into respective first metadata according to a library of metadata values and abstracting the second enterprise information into respective second metadata according to the library of metadata values. The first and second metadata may be stored, e.g., in a database or blockchain. It will be acknowledged that prior stored enterprise information and/or enterprise information metadata for a plurality of enterprises may be retrievably stored at the database and/or blockchain. The step 810 of cross-tabulating one or more of the data entities of the first enterprise information against corresponding data entities of the second enterprise information may include cross-tabulating the first metadata against corresponding instances of the second metadata.

According to an embodiment, the step 812—stack ranking plural sets of enterprise information corresponding respectively to a plurality of enterprises, other than the first enterprise, in order of best match of each respective set of enterprise information to the first enterprise information—may include stack ranking plural sets of enterprise information metadata respectively associated with a plurality of enterprises, other than the first enterprise, in order of best match of each respective set of enterprise information metadata to the first metadata.

According to an embodiment, the step 814 may include presenting, to the first enterprise, at least information from a selected set of enterprise information metadata selected from the stack ranked sets of enterprise information metadata. Accordingly step 816, may include presenting, to the enterprise corresponding to the selected set of enterprise information metadata, at least information corresponding to the first enterprise metadata.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1. A computer method for licensing proprietary rights using a blockchain, comprising:
displaying a graphical user interface (GUI) to a first user representing a first enterprise, the GUI including a selection object for selecting one from one or more standard proprietary rights agreements;
receiving, into a server computer from the first user via the GUI, a selection of one of the one or more standard proprietary rights agreements for making a proprietary rights agreement with a second enterprise;
providing, via the GUI, an executable electronic document corresponding to the selected proprietary rights agreement to a user having signature authority and representing the first enterprise and to a user having signature authority and representing the second enterprise;
receiving, into the server computer, data corresponding to execution of the electronic document from the first enterprise and the second enterprise; and
recording the execution of the selected proprietary rights agreement between the first and second enterprises on a blockchain.

2. The computer method for licensing proprietary rights using a blockchain of claim 1, further comprising:
establishing, and recording as a transaction on the blockchain, a negotiation between the first and second enterprises.

3-4. (canceled)

5. The computer method for licensing proprietary rights using a blockchain of claim 2,
wherein establishing a negotiation between the first and second enterprises includes receiving acceptance of the invitation from the first and second enterprises and establishing a confidential disclosure agreement (CDA) between the first and second enterprises, and
wherein recording a negotiation between the first and second enterprises includes recording execution of the CDA on the blockchain as a transaction.

6. (canceled)

7. The computer method for licensing proprietary rights using a blockchain of claim 2, wherein establishing a negotiation between the first and second enterprises includes executing, with the server computer, a matching function between the first and second enterprises.

8. (canceled)

9. The computer method for licensing proprietary rights using a blockchain of claim 7, wherein the matching function includes determining whether differing or matching metadata about the first and second enterprises is complementary, with no analysis being performed.

10. The computer method for licensing proprietary rights using a blockchain of claim 7, wherein the matching function includes at least one of:
matching a multinational corporation (MNC) with a start-up company having a capability desired by the multinational corporation;
determining whether differing proprietary rights held by the first and second enterprises are complementary;
determining whether differing technical capabilities of the first and second enterprises are complementary;
determining a complementariness of non-matching production capabilities of the first and second enterprises;
determining a complementariness of differing territories addressed by the first and second enterprises;
determining a complementariness of differing sales channels used by the first and second enterprises;
determining a complementariness of differing sizes of the first and second enterprises; and/or
determining a complementariness of differing financial resources of the first and second enterprises.

11-17. (canceled)

18. The computer method for licensing proprietary rights using a blockchain of claim 1, wherein displaying a GUI to a first user includes displaying a selection object for selecting a brand license.

19. The computer method for licensing proprietary rights using a blockchain of claim 18, wherein one of the first user and the second enterprise represents the start-up company and the other one of the first user and the second enterprise represents the multinational corporation.

20. (canceled)

21. The computer method for licensing proprietary rights using a blockchain of claim 18, wherein receiving the selection of one of a one or more standard proprietary rights agreements includes receiving a selection of a brand license;
wherein providing an executable electronic document includes providing an executable electronic brand license; and
wherein recording the execution of the proprietary rights agreement includes recording the execution of the brand license.

22. The computer method for licensing proprietary rights using a blockchain of claim 1,
wherein displaying a GUI to a first user includes displaying a selection object for selecting a build-to-buy agreement;
wherein receiving the selection of one of the one or more standard proprietary rights agreements includes receiving a selection of the build-to-buy agreement;
wherein providing an executable electronic document includes providing an executable electronic build-to-buy agreement; and
wherein recording the execution of the proprietary rights agreement includes recording the execution of the build-to-buy agreement.

23. (canceled)

24. The computer method for licensing proprietary rights using a blockchain of claim 1,
wherein displaying a GUI to a first user includes displaying a selection object for selecting a co-marketing agreement;
wherein receiving the selection of one of the one or more standard proprietary rights agreements includes receiving a selection of the co-marketing agreement;
wherein providing an executable electronic document includes providing an executable electronic co-marketing agreement; and
wherein recording the execution of the proprietary rights agreement includes recording the execution of the co-marketing agreement.

25. (canceled)

26. The computer method for licensing proprietary rights using a blockchain of claim 1,
wherein displaying a GUI to a first user includes displaying a selection object for selecting a distribution agreement;
wherein receiving the selection of one of the one or more standard proprietary rights agreements includes receiving a selection of the distribution agreement;
wherein providing an executable electronic document includes providing an executable electronic distribution agreement; and
wherein recording the execution of the proprietary rights agreement includes recording the execution of the distribution agreement.

27. (canceled)

28. The computer method for licensing proprietary rights using a blockchain of claim 1,
wherein displaying a GUI to a first user includes displaying a selection object for selecting a foreign rights agreement;
wherein receiving the selection of one of the one or more standard proprietary rights agreements includes receiving a selection of the foreign rights agreement;
wherein providing an executable electronic document includes providing an executable electronic foreign rights agreement; and
wherein recording the execution of the proprietary rights agreement includes recording the execution of the foreign rights agreement.

29. (canceled)

30. The computer method for licensing proprietary rights using a blockchain of claim 1,
wherein displaying a GUI to a first user includes displaying a selection object for selecting a foreign rights sublicense agreement;
wherein receiving the selection of one of the one or more standard proprietary rights agreements includes receiving a selection of the foreign rights sublicense agreement;
wherein providing an executable electronic document includes providing an executable electronic foreign rights sublicense agreement; and
wherein recording the execution of the proprietary rights agreement includes recording the execution of the foreign rights sublicense agreement.

31. (canceled)

32. The computer method for licensing proprietary rights using a blockchain of claim 1,
wherein displaying a GUI to a first user includes displaying a selection object for selecting an IP sales agreement;
wherein receiving the selection of one of the one or more standard proprietary rights agreements includes receiving a selection of the IP sales agreement;
wherein providing an executable electronic document includes providing an executable electronic IP sales agreement; and
wherein recording the execution of the proprietary rights agreement includes recording the execution of the IP sales agreement.

33. (canceled)

34. The computer method for licensing proprietary rights using a blockchain of claim 1,
wherein displaying a GUI to a first user includes displaying a selection object for selecting a exclusive IP licensing agreement;
wherein receiving the selection of one of the one or more standard proprietary rights agreements includes receiving a selection of the exclusive IP licensing agreement;
wherein providing an executable electronic document includes providing an executable electronic exclusive IP licensing agreement; and
wherein recording the execution of the proprietary rights agreement includes recording the execution of the exclusive IP licensing agreement.

35. (canceled)

36. The computer method for licensing proprietary rights using a blockchain of claim 1,
wherein displaying a GUI to a first user includes displaying a selection object for selecting a non-exclusive IP licensing agreement;
wherein receiving the selection of one of the one or more standard proprietary rights agreements includes receiving a selection of the non-exclusive IP licensing agreement;
wherein providing an executable electronic document includes providing an executable electronic non-exclusive IP licensing agreement; and
wherein recording the execution of the proprietary rights agreement includes recording the execution of the non-exclusive IP licensing agreement.

37. (canceled)

38. The computer method for licensing proprietary rights using a blockchain of claim 1,
wherein displaying a GUI to a first user includes displaying a selection object for selecting a supply agreement;
wherein receiving the selection of one of the one or more standard proprietary rights agreements includes receiving a selection of the supply agreement;
wherein providing an executable electronic document includes providing an executable electronic supply agreement; and
wherein recording the execution of the proprietary rights agreement includes recording the execution of the supply agreement.

39. (canceled)

40. The computer method for licensing proprietary rights using a blockchain of claim 1,
wherein displaying a GUI to a first user includes displaying a selection object for selecting a technology co-development agreement;
wherein receiving the selection of one of the one or more standard proprietary rights agreements includes receiving a selection of the technology co-development agreement;
wherein providing an executable electronic document includes providing an executable electronic technology co-development agreement; and
wherein recording the execution of the proprietary rights agreement includes recording the execution of the technology co-development agreement.

41. (canceled)

42. The computer method for licensing proprietary rights using a blockchain of claim 1, wherein displaying a GUI to a first user includes displaying a selection object for selecting a trade secrets and/or know how transfer agreement;
wherein receiving the selection of one of the one or more standard proprietary rights agreements includes receiving a selection of the trade secrets and/or know how transfer agreement;
wherein providing an executable electronic document includes providing an executable electronic trade secrets and/or know how transfer agreement; and
wherein recording the execution of the proprietary rights agreement includes recording the execution of the trade secrets and/or know how transfer agreement.

43. (canceled)

44. The computer method for licensing proprietary rights using a blockchain of claim 1, wherein one of the first enterprise and the second enterprise is a multinational corporation and/or a large entity having over 400 employees and the other one of the first enterprise and the second enterprise is a start-up enterprise and/or a small entity having under 400 employees.

45-47. (canceled)

48. The computer method for licensing proprietary rights using a blockchain of claim 1, wherein recording the execution of the selected proprietary rights agreement includes hashing the executed agreement.

49. The computer method for licensing proprietary rights using a blockchain of claim 1, wherein recording the execution of the selected proprietary rights agreement includes encrypting data corresponding to the executed agreement.

50. The computer method for licensing proprietary rights using a blockchain of claim 1, wherein recording the execution of the selected proprietary rights agreement includes recording data corresponding to the executed agreement as a transaction on the blockchain.

51. The computer method for licensing proprietary rights using a blockchain of claim 1, wherein recording the execution of the selected proprietary rights agreement includes recording data corresponding to the executed agreement as metadata on the blockchain.

52. The computer method for licensing proprietary rights using a blockchain of claim 1, wherein the blockchain comprises a distributed ledger.

53. The computer method for licensing proprietary rights using a blockchain of claim 1, wherein the blockchain comprises a permissioned blockchain.

54. The computer method for licensing proprietary rights using a blockchain of claim 1, wherein the blockchain comprises a private blockchain.

55. The computer method for licensing proprietary rights using a blockchain of claim 1, wherein the blockchain comprises a public blockchain.

56. The computer method for licensing proprietary rights using a blockchain of claim 1, wherein the selected proprietary rights agreement comprises a non-disclosure agreement and/or a confidential disclosure agreement that is one-way or bilateral.

57. The computer method for licensing proprietary rights using a blockchain of claim 1, further comprising:
receiving variable information pertaining to the proprietary rights agreement via the GUI, wherein receiving the variable information includes at least one of:
receiving radio button selections in the GUI;
receiving entries in fields in the GUI;
receiving an uploaded term sheet;
receiving at least one negotiated item; and/or
receiving at least one selected from the group consisting of a price, a duration, a territory, a payment frequency, a payment schedule, a patent number, a trademark, an application serial number, a publication number, and an exclusion.

58-64. (canceled)

65. The computer method for licensing proprietary rights using a blockchain of claim 1, wherein recording the executed proprietary rights agreement includes running the executed proprietary rights agreement through a Merkle tree.

66. The computer method for licensing proprietary rights using a blockchain of claim 1, wherein recording the executed proprietary rights agreement includes encrypting the executed proprietary rights agreement.

67. The computer method for licensing proprietary rights using a blockchain of claim 1, wherein recording the executed proprietary rights agreement on a blockchain includes recording on at least one selected from the group consisting of a public blockchain, an etherium ERC-20 blockchain, a permissioned blockchain, a private blockchain, and a distributed ledger.

68. The computer method for licensing proprietary rights using a blockchain of claim 1, further comprising:
transmitting cryptographic keys to the first and second enterprises.

69. The computer method for licensing proprietary rights using a blockchain of claim 7, wherein the matching function includes:
receiving first enterprise information from the first enterprise, the first enterprise information including information corresponding to one or more data entities including one or more of preferences, type of relationship sought, non-secret overview information, secret relationship information, and secret detailed data;
storing the first enterprise information at a first distributed memory location;
receiving second enterprise information from the second enterprises, the second enterprise information including information corresponding to the one or more data entities; and
storing the second enterprise information at a second distributed memory location.

70. The computer method for licensing proprietary rights using a blockchain of claim 69, further comprising:
cross-tabulating one or more of the data entities of the first enterprise information against corresponding data entities of the second enterprise information;
stack ranking plural sets of enterprise information corresponding respectively to a plurality of enterprises, other than the first enterprise, in order of best match of each respective set of enterprise information to the first enterprise information;
presenting, to the first enterprise, at least information from a selected set of enterprise information selected from the stack ranked sets of enterprise information; and
presenting, to an enterprise corresponding to the selected set of enterprise information, at least information corresponding to the first enterprise.

71-73. (canceled)

74. The computer method for licensing proprietary rights using a blockchain of claim 69, wherein the matching function further includes:
abstracting the first enterprise information into respective first metadata according to a library of metadata values;
abstracting the second enterprise information into respective second metadata according to the library of metadata values;
saving the first and second metadata in a blockchain; and
cross-tabulating the first metadata against corresponding instances of the second metadata.

75. The computer method for licensing proprietary rights using a blockchain of claim 74, further comprising:
stack ranking plural sets of enterprise information metadata respectively associated with a plurality of enterprises, other than the first enterprise, in order of best match of each respective set of enterprise information metadata to the first metadata; and
presenting, to the first enterprise, at least information from a selected set of enterprise information metadata selected from the stack ranked sets of enterprise information metadata.

76. (canceled)

77. The computer method for licensing proprietary rights using a blockchain of claim 76, further comprising:
presenting, to an enterprise corresponding to the selected set of enterprise information metadata, at least information corresponding to the first enterprise metadata.
